(19) United States
(12) Patent Application Publication
(10) Pub. No.: US 2009/0116558 A1
(43) Pub. Date: May 7, 2009

(54) Motion skip and single-loop encoding for multi-view video content

(75) Inventors: Ying Chen, Tampere (FI); Ye-Kui Wang, Tampere (FI); Miska Hannuksela, Ruutana (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/287,909

(22) Filed: Oct. 15, 2008

Related U.S. Application Data
(60) Provisional application No. 60/980,161, filed on Oct. 15, 2007.

(51) Int. Cl. H04N 7/26

(52) U.S. Cl. 375/240.16; 375/E07.125

(57) ABSTRACT

A system, method and computer program tangibly embodied in a memory medium for implementing motion skip and single-loop decoding for multi-view video coding. In various embodiments, a more efficient motion skip is used for the current JMVM arrangement by 8×8 or 4×4 pel disparity motion vector accuracy, while maintaining the motion compensation process that is compliant with the H.264/AVC design regarding hierarchical macroblock partitioning. Adaptive referencing merging may be used in order achieve a more accurate motion skip from one inter-view reference picture. In order to indicate whether a picture is to be used for motion skip, a new syntax element or syntax modification in the NAL unit header may be used.

### CROSS-REFERENCE TO RELATED APPLICATIONS

This patent application claims priority under 35 U.S.C. §119(e) from Provisional Patent Application No. 60/980,161, filed Oct. 15, 2007, the disclosure of which is incorporated by reference herein in its entirety.

### FIELD OF THE INVENTION

The exemplary embodiments of this invention relate generally to video coding and, more specifically, relate to video coding for multi-view video content.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC Moving Picture Experts Group (MPEG)-1 Visual, ITU-T H.262 or ISO/IEC MPEG-2 Video, ITU-T H.263, ISO/IEC MPEG-4 Visual and ITU-T H.264 (also know as ISO/IEC MPEG-4 Advanced Video Coding (AVC)). In addition, there are currently efforts underway with regards to the development of new video coding standards. One such standard under development is the scalable video coding (SVC) standard, which will become the scalable extension to H.264/AVC. Another such standard under development is the multi-view video coding (MVC) standard, which will become another extension to H.264/AVC.

In multi-view video coding, video sequences output from different cameras, each corresponding to different views, are encoded into one bit-stream. After decoding, to display a certain view, the decoded pictures belonging to that view are reconstructed and displayed. It is also possible for more than one view to be reconstructed and displayed. Multi-view video coding has a wide variety of applications, including free-viewpoint video/television, 3D TV, and surveillance applications. Currently, the Joint Video Team (JVT) of ISO/IEC Motion Picture Expert Group (MPEG) and ITU-T Video Coding Expert Group is working to develop a MVC standard, which is becoming an extension of H.264/AVC. These standards are referred to herein as MVC and AVC, respectively.

The latest working draft of MVC is described in JVT-X209, “Joint Draft 4.0 on Multiview Video Coding,” 24th JVT meeting, Geneva, Switzerland, June-July 2007, available at ftp3.itu.ch/av-arch/jvt-site/2007_{—}06_Geneva/JVT-X209.zip. Besides the features defined in the working draft of MVC, other potential features, particularly those focusing on coding tools, are described in Joint Multiview Video Model (JMVM). The latest version of JMVM is described in JVT-X207, “Joint Multiview Video Model (JMVM) 5.0,” 24th JVT meeting, Geneva, Switzerland, June-July 2007, available at ftp3.itu.ch/av-arch/jvt-site/2007_{—}06_Geneva/JVT-X207.zip.

FIG. 1 is a representation showing a typical MVC decoding order (i.e., bitstream order). The decoding order arrangement is referred to as time-first coding. Each access unit is defined to contain the coded pictures of all the views for one output time instance. It should be noted that the decoding order of access units may not be identical to the output or display order. A typical MVC prediction (including both inter-picture prediction within each view and inter-view prediction) structure for multi-view video coding is shown in FIG. 2. In FIG. 2, predictions are indicated by arrows, with each pointed-to object using the respective point-from object for prediction reference.

Conventionally, multiple-loop decoding is used in MVC. In multiple-loop decoding, in order to decode a target view, besides the target view itself, each view that is required by the target view for inter-view prediction also needs to be fully reconstructed with a motion compensation loop. For example, if only view 1 is output, shown in FIG. 2 as S1, then all of the pictures in view 0 and view 2 must be fully reconstructed. Multiple-loop decoding requires much more computation and memory compared to single-view coding, where each view is independently coded into its own bitstream using e.g., H.264/AVC. This is because, in multiple-loop decoding, all of the pictures belonging to other views but needed for inter-view prediction must be fully reconstructed and stored in the decoded picture buffer.

In MVC Joint Draft (JD) 4.0, view dependencies are specified in the sequence parameter set (SPS) MVC extension. The dependencies for anchor pictures and non-anchor pictures are independently specified. Therefore, anchor pictures and non-anchor pictures can have different view dependencies. However, for the set of pictures that refer to the same SPS, all of the anchor pictures must have the same view dependency, and all of the non-anchor pictures must have the same view dependency. In the SPS MVC extension, dependent views are signaled separately for the views used as reference pictures in RefPicList0 and RefPicList1.

There are a number of use cases where only a subset of the encoded views are required for output. Those particular views are referred to as target views or output views. Target views may depend on other views, which are not for output, for decoding. Those particular views that are depended on by target views but are not used for output are referred to as dependent views.

Pictures used by a picture P for inter-view prediction are referred to as inter-view reference pictures of picture P. An inter-view reference picture may belong to either a target view or a dependent view. Although a view is depended upon by other views according to the view dependency signaled in the SPS MVC extension, a specific picture in one view can be never used for inter-view prediction. In JD 4.0, there is an inter_view_flag in the network abstraction layer (NAL) unit header which indicates whether the picture containing the NAL unit is used for inter-view prediction for the pictures in other views.

Dependent views can be signaled in two directions. These directions correspond to inter-view prediction reference pictures for the two reference picture lists, namely the first reference picture list, RefPicList0, referred to as the forward reference picture list, and the second reference picture list, RefPicList1, referred to as backward reference picture list. The dependent views corresponding to RefPicList0 are referred to as forward dependent views, and the dependent views corresponding to RefPicList1 are referred to as backward dependent views. For the example shown in FIG. 2, view 0 is the forward dependent view of view 1, while view 2 is the backward dependent view of view 2.

In MVC JD 4.0, inter-view prediction is supported by only texture prediction (i.e. only the reconstructed sample values may be used for inter-view prediction), and only the reconstructed pictures of the same output time instance as the current picture are used for inter-view prediction. As discussed herein, the traditional inter-view prediction in MVC JD 4.0 is referred to as inter-view sample prediction.

As a coding tool in JMVM, motion skip predicts macroblock (MB) modes and motion vectors from the inter-view reference pictures and it applies to non-anchor pictures only. During encoding, a global disparity motion vector (GDMV) is estimated when encoding an anchor picture, and GDMVs for non-anchor pictures are then derived so that the GDMVs for a non-anchor picture is a weighted average from the GDMVs of the two neighboring anchor pictures. A GDMV is of 16-pel precision, i.e., for any MB in the current picture (i.e. the picture being encoded or decoded), the corresponding region shifted in an inter-view reference picture according to the GDMV covers exactly one MB in the inter-view reference picture.

For simplicity purposes, the collective term “co-located blocks” is used herein to describe the corresponding 4×4, 8×4, 4×8 blocks or 8×8 MB partition in the inter-view reference picture after motion disparity compensation. In some cases, the term “co-located MB partition” is used to describe the corresponding MB partition, and the term “co-located MB” is used to describe the corresponding MB.

Normally, the picture from the first forward dependent view is used as the motion skip inter-view reference picture. However, if the co-located MB in the picture of the first forward dependent view is Intra coded, then the other candidate, the co-located MB from the picture in the first backward dependent view, if present, is considered. If both of these MBs are Intra coded, then the current MB cannot be coded using motion skip.

An example of motion skip is shown in FIG. 3, wherein view 0 is the dependent view and view 1 is the target view (marked, as “Current Decoding View” in FIG. 3) which is to be output and displayed. With the disparity motion, when decoding MBs in view 1, the corresponding MBs in view 0 are located and their modes and motion vectors are reused as the MB modes and motion vectors for the MBs in view 1. Unlike in inter-view sample prediction, which corresponds to multiple-loop decoding because it requires motion compensation for the inter-view reference pictures used for inter-view sample prediction, motion skip itself does not require motion compensation of the inter-view reference pictures used for motion skip. However, in the current draft MVC standard, because inter-view sample prediction and motion skip exist simultaneously, multiple loop decoding is needed.

Single-loop decoding (SLD) is supported in the scalable extension of H.264/AVC, also known as SVC. The SVC specification is described in JVT-X201, “Joint Draft 11 of SVC Amendment”, 24th JVT meeting, Geneva, Switzerland, June-July 2007, available at ftp3.itu.ch/av-arch/jvt-site/2007_{—}06_Geneva/JVT-X201.zip. The basic concept of SLD in SVC is as follows. To decode a target layer that depends on a number of lower layers, only the target layer itself needs to be fully decoded. For the lower layers, only parsing and decoding of Intra MBs are needed. SLD in SVC requires motion compensation only at the target layer. Consequently, SLD provides a significant reduction in complexity. Furthermore, since the lower layers do not need motion compensation, and no sample values need to be stored in the decoded picture buffer (DPB), the decoder memory requirement is significant reduced compared to multiple-loop decoding, where motion compensation and full decoding is needed in every layer, as in the scalable profiles of earlier video coding standards. The same rationale can be applied to MVC such that only the target views are fully decoded.

The following is a discussion of selected features of H.264/AVC. In H.264/AVC, MBs in a slice can have different reference pictures for Inter prediction. The reference picture for a specific MB or MB partition is selected from the reference picture lists which provide indices to the decoded pictures available in the decoded picture buffer and used for prediction reference. For each MB or MB partition and each prediction direction, a reference index is signaled to assign a reference picture for Inter prediction.

The reference picture lists construction in H.264/AVC can be described as follows. First, an initial reference picture list is constructed including all of the short-term and long-term reference pictures that are marked as “used for reference.” Reference picture list reordering (RPLR) is then performed when the slice header contains RPLR commands. The RPLR process may reorder the reference pictures into a different order than the order in the initial list. Both the initial list and final list after reordering contain only a certain number of entries indicated by a syntax element in the slice header or the picture parameter set referred by the slice.

In H.264/AVC, each picture is coded as one or more slices, which may comprise five slice types—I, SI, P, SP or B. MBs in I slices are coded as Intra MBs. MBs in P or B slices are coded as Intra MBs or Inter MBs. Each Inter MB in a P slice is either an Inter-P MB or consists of Inter-P MB partitions. Each Inter MB in a B slice is an Inter-P MB or an Inter-B MB, or consists of Inter-P MB partitions or Inter-B MB partitions. For an Inter-P MB or MB partition, prediction from only one direction can be used. For Inter-B MB or MB partitions, prediction from both directions can be used, wherein two prediction blocks from two reference pictures are weighted sample-wise to get the final prediction MB or MB partition.

For Inter-P MBs or MB partitions in P slices, the only prediction direction is from the RefPicList0. The prediction from the RefPicList0 is referred to as forward prediction, although the reference picture can be before or after the current picture in the display order. For Inter-P MBs or MB partitions in B slices, the only prediction direction can be from either RefPicList0 or RefPicList1. When the prediction is from RefPicList0, it is referred to as forward prediction. Otherwise, it is referred to as backward prediction.

When an MB or MB partition has a reference index from only RefPicList0, its referencing status is defined as forward predicted. When the MB or MB partition has a reference index from only RefPicList1, the referencing status is defined as backward predicted. When the MB or MB partition has two reference indices from both RefPicList0 and RefPicList1, the referencing status is defined as bi-predicted.

For any MB or MB partition, depending on the coding mode, its referencing status can be one of (a) Intra, (b) Inter-B (bi-predicted), (c) Inter-P forward predicted, and (d) Inter-P backward predicted. The first status is noted as illegal herein, and the other three status indications are legal.

For each MB, the MB can be coded as Intra MB or Inter MB. When an MB is Inter coded, it may be further partitioned into MB partitions, which are of 16×16, 16×8, 8×16 or 8×8 sizes, as shown in the upper portion of FIG. 4. Each MB or MB partition shares the same referencing status and the same reference index (indices, if bi-predicted). Furthermore, each MB or MB partition can be partitioned into 8×8, 8×4, 4×8 or 4×4 blocks (or sub-macroblock partitions), as shown in the bottom portion of FIG. 4. The samples in each block share the same motion vector (or 2 motion vectors for bi-prediction, with one motion vector for each direction). The H.264/AVC based or compliant standards developed thus far all follow this hierarchical MB partitioning because it will make the hardware design module for the motion compensation part applicable to the extension standards of the H.264/AVC.

For each MB, MB partition, or 4×4 block, if inter prediction from RefPicListX is used, this MB, MB partition, or 4×4 block is denoted with “use ListX” (with X being 0 or 1). Otherwise, this MB, MB partition, or 4×4 block is denoted as “not use ListX”.

The conventional motion skip method in JMVM is based on global disparity motion, and the global disparity motion has an accuracy of 16 pel in both the horizontal and vertical directions. With 16 pel accuracy global disparity motion, the motion vectors and the mode of complete MBs are directly copied, such that this information does not need to be calculated block by block. However, the accuracy of global disparity motion affects the performance of the motion skip, as more accurate global disparity motion may result in a more efficient motion skip and therefore higher coding efficiency. Usually this global motion can be found by image registration algorithms, wherein a displacement is the solution for an optimization problem. When 8-pel accuracy is utilized, in each direction (x axis or y axis) of the displacement, one unit corresponds to 8 pixels. Thus the co-located MBs are aligned with the boundaries of 8×8 blocks in the inter-view reference picture. When 4-pel accuracy is utilized, in each direction (x axis or y axis) of the displacement, one unit corresponds to 4 pixels. Therefore, the co-located MBs are aligned with the boundaries of those 4×4 blocks in the inter-view reference picture.

One test of the test sequence has involved searching for optimal displacement with 4-pel accuracy for picture pairs within the same time instance but from different views.

In this test, the percentage of picture pairs with an optimal displacement that leads to MB boundary alignment (displacement values in x and y axis can be divided exactly by 4) was about 20%. This indicates that 4-pel accuracy-based registration can provide better registration performance than 16-pel accuracy based registration.

In H.264/AVC, motion vectors in the motion field can be allocated to each 4×4 block, i.e., the sample of the motion field is of 4-pel accuracy. Therefore, the disparity motion, which aims for the reuse of motion vectors from inter-view reference pictures, can conveniently have the same accuracy.

When the motion disparity is of 4-pel accuracy, and assuming that each unit of a motion disparity value represents 4 pixels, each 8×8 MB partition in the current picture can be located into four 8×8 MB partitions, e.g., as shown in FIGS. 5 and 6, one 8×8 MB partition, e.g., as shown in FIG. 7, or two 8×8 MB partitions, e.g., as shown in FIG. 8. The values of the motion disparities in the first case are congruent to (1,1) modulo 2, in the second case the values are congruent to (0,0) modulo 2, and in the third case the values are congruent to (1,0) or (0,1) modulo 2. As used herein and unless stated explicitly, an MB partition by default refers to an 8×8 MB partition, and a block by default refers to a 4×4 block.

When the disparity motion is of 4-pel, a number of issues may arise. In a B slice, according to H.264/AVC hierarchical macroblock partitioning, all blocks in each MB partition must simultaneously be forward predicted (“use List0” but “not use List1”), backward predicted (“use List1,” but “not use List0”), or bi-predicted (“use List0” and “use List1”). However, if the disparity vector is congruent to (1,1) modulo 2, then the co-located MB partition may break this rule. For example and as shown in FIG. 5, the four co-located blocks of the co-located MB partition belong to four MB partitions that are backward predicted, forward predicted, bi-predicted, and bi-predicted respectively.

Additionally, when multiple reference pictures are used, the MB partitions can have different reference indices and refer to different reference pictures. If the disparity vector is congruent to (1, 1) modulo 2, as shown in FIG. 6, then there are four MB partitions from the inter-view reference picture that cover the top-left co-located MB partition in the co-located MB. Those 8×8 MB partitions may have different reference indices. For example, reference indices can be 0, 1, 2, and 0, respectively, at the forward prediction direction, as shown in FIG. 6. However, whenever “use ListX” (with X being 0 or 1), blocks in an 8×8 MB partition of an Inter MB in H.264/AVC can only have the same reference index for one prediction direction, according to the H.264/AVC hierarchical macroblock partitioning.

Furthermore, if the disparity vector is congruent to (0,0) modulo 2, and the disparity vector is aligned with 8×8 block (or say MB partition) boundaries, a situation may occur where one or more co-located MB partitions in the co-located MB correspond to pixels in Intra MBs from the inter-view reference picture being considered for motion skip. For example and as shown in FIG. 7, the top-right 8×8 MB partition of the current MB corresponds to pixels in an Intra MB. Therefore, motion skip cannot be used since there is no motion information to be copied for the top-right 8×8 MB partition. This issue also exists when the disparity motion vector is of 8-pel accuracy (where each unit of a disparity motion vector represents 8 pixels) and the value is not congruent to (0, 0) modulo 2.

In addition to the above, a number of issues exist with regard to motion skip signaling. For example, for a picture in a dependent view, it can be determined from the view dependency that it may be used as an inter-view reference picture. However, it cannot be known whether it is used for inter-view sample prediction or for motion skip. The inter_view_flag in the NAL unit header indicates whether a picture is used for inter-view sample prediction by any other views. If a dependent view picture is only used for motion skip, then reconstruction of the sample values, which requires motion compensation if the picture is inter-coded, is not needed. Consequently, the decoder conventionally still has had to fully decode the picture and store the decoded picture, even if the picture is only used for motion skip. This results in higher complexity and additional memory usage.

Additionally, while some slices may benefit from motion skip, other slices may not benefit from it. However, in the conventional JMVM arrangement, each MB has required an indication to indicate whether motion skip is used in that MB. This unnecessarily wastes bits and decreases coding efficiency.

Furthermore, the conventional JMVM arrangement only signals the global disparity motion at anchor pictures, which causes a number of its own issues. These issues include (1) the fact that the optimal disparity may vary picture by picture and, thus, the derived disparity may not be optimal for all the pictures; and (2) the inter-view reference pictures for anchor pictures may be different from those for non-anchor pictures, meaning that, for a certain non-anchor picture, the disparity motion signaled in the two neighboring anchor picture with respect to an inter-view reference picture may not be applicable even after being weighted.

Still further, for a certain MVC bitstream, for all of the non-anchor pictures, if inter-view prediction from dependent views consists of only motion skip, i.e., without inter-view sample prediction, then dependent views do not need to be fully reconstructed at non-anchor pictures. Instead, non-anchor pictures in the dependent views can simply be parsed to obtain MB modes and motion information for motion skip. However, in the conventional arrangement the decoder does not know that single-loop decoding may be possible.

In addition to the above, current motion skip is based on global disparity motion. In practice, however, the optimal transformation between two views maybe non-linear, and objects with different depths and different locations may need different disparities. In some sequences with motion activity varying quickly from one small area to another, the global disparity is not accurate enough for every MB. Therefore, the motion skip coding system is sub-optimal from coding efficiency point of view.

### SUMMARY OF THE EXEMPLARY EMBODIMENTS OF THE INVENTION

The foregoing and other problems are overcome, and other advantages are realized, by the use of the exemplary embodiments of this invention.

In a first aspect thereof the exemplary embodiments of this invention provide a method that includes encoding a first sequence of input pictures and a second sequence of input pictures into a bitstream, where a first input picture of the first sequence of input pictures may or may not be intended for output, and where a second input picture of the second sequence of input pictures is intended for output; including a disparity signal indication indicative of a disparity motion; using a motion derivation method to derive at least one motion vector from the first input picture according to the disparity motion; and using the at least one derived motion vector in encoding the second input picture.

In another aspect thereof the exemplary embodiments of this invention provide an apparatus that includes a processor and a memory unit communicatively connected to the processor and including computer code configured to encode a first sequence of input pictures and a second sequence of input pictures into a bitstream, wherein a first input picture of the first sequence of input pictures may or may not be intended for output, and wherein a second input picture of the second sequence of input pictures is intended for out; computer code configured to include, a disparity signal indication indicative of a disparity motion; computer code configured to use a motion derivation method to derive at least one motion vector from the first input picture according to the disparity motion; and computer code configured to use the at least one derived motion vector in encoding the second input picture.

In another aspect thereof the exemplary embodiments of this invention provide an apparatus that comprises means for encoding a first sequence of input pictures and a second sequence of input pictures into a bitstream, wherein a first input picture of the first sequence of input pictures may or may not be intended for output, and wherein a second input picture of the second sequence of input pictures is intended for output; means for including a disparity signal indication indicative of a disparity motion; means for using a motion derivation method to derive at least one motion vector from the first input picture according to the disparity motion; and means for using the at least one derived motion vector in encoding the second input picture.

In a further aspect thereof the exemplary embodiments of this invention provide a method, a computer program and an apparatus configured to encode a first sequence of input pictures and a second sequence of input pictures into a bitstream; and to signal in a slice header of the first sequence of input pictures whether motion is generated by derivation from pictures in the second sequence.

In a further aspect thereof the exemplary embodiments of this invention provide a method, a computer program and an apparatus configured to encode a first sequence of input pictures and a second sequence of input pictures into a bitstream; and to signal in a network abstraction layer unit header whether a picture of the second sequence of input pictures is used by at least one picture in the first sequence of input pictures for motion skip.

In another aspect thereof the exemplary embodiments of this invention provide a method, a computer program and an apparatus configured to receive a first sequence of input pictures and a second sequence of input pictures from a bitstream; to receive a signal in a network abstraction layer unit header, the signal indicating whether a picture of the second sequence of input pictures is used by at least one picture in the first sequence of input pictures for motion skip and, if the signal indicates that a picture of the second sequence of input pictures is used by at least one picture in the first sequence of input pictures for motion skip, to use the picture in the second sequence of input pictures for motion skip when decoding the at least one picture in the first sequence of input pictures.

In another aspect thereof the exemplary embodiments of this invention provide a method, a computer program and an apparatus configured to receive a first sequence of input pictures and a second sequence of input pictures, a slice header of the first sequence of input pictures including a signal regarding whether motion is generated by derivation from pictures in the second sequence and, if the signal in the slice header of the first sequence of input pictures indicates that motion is generated by derivation from pictures in the second sequence, to use motion derived from the pictures in the second sequence to decode at least one of the first sequence of input pictures.

In yet another aspect thereof the exemplary embodiments of this invention provide a method, a computer program and an apparatus configured to encode a first sequence of input pictures and a second sequence of input pictures into a bitstream, where a first input picture of the first sequence of input pictures may or may not be intended for output, and where a second input picture of the second sequence of input pictures is intended for output; to include a disparity signal indication indicative of a macroblock disparity motion; to use a motion derivation method to derive at least one motion vector from the first input picture according to the disparity motion; and to use the at least one derived motion vector for motion compensation.

In a still further aspect thereof the exemplary embodiments of this invention provide an apparatus that comprises means for encoding a first sequence of input pictures and a second sequence of input pictures into a bitstream, where a first input picture of the first sequence of input pictures may or may not be intended for output, and where a second input picture of the second sequence of input pictures is intended for output; means for including a disparity signal indication indicative of a macroblock disparity motion. The apparatus further comprises means for using a motion derivation method to derive at least one motion vector from the first input picture according to the disparity motion, the at least one derived motion vector being used for motion compensation. The apparatus further comprises means for including at least one further indication in the bitstream, the at least one further indication being indicative of at least one of whether a picture is used in the deriving of the at least one motion vector, whether a view uses any other view for inter-view sample prediction, and whether single-loop decoding is supported for a view.

### BRIEF DESCRIPTION OF THE DRAWINGS

FIG. 1 is a representation showing a typical MVC decoding order (i.e. bitstream order);

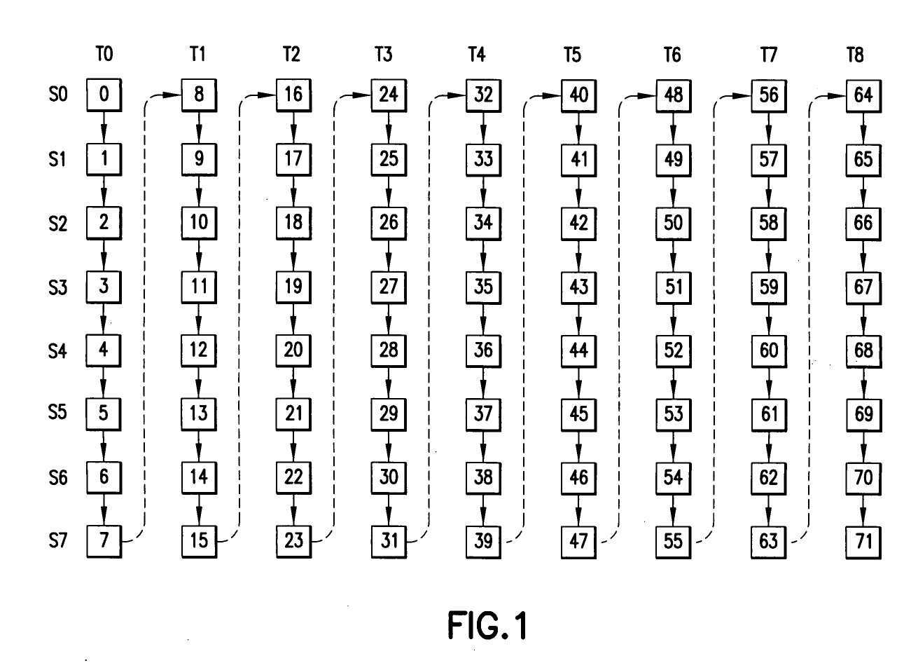

FIG. 2 is a representation of a typical MVC prediction (including both inter-picture prediction within each view and inter-view prediction) structure for multi-view video coding;

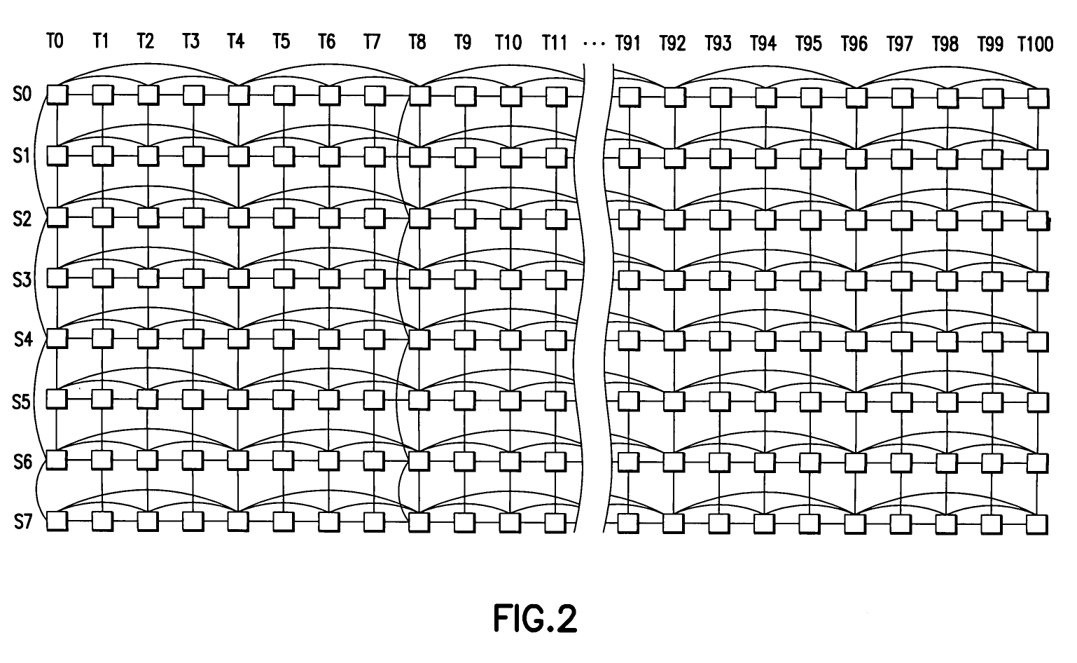

FIG. 3 is a depiction showing an example of motion skip using disparity motion vectors;

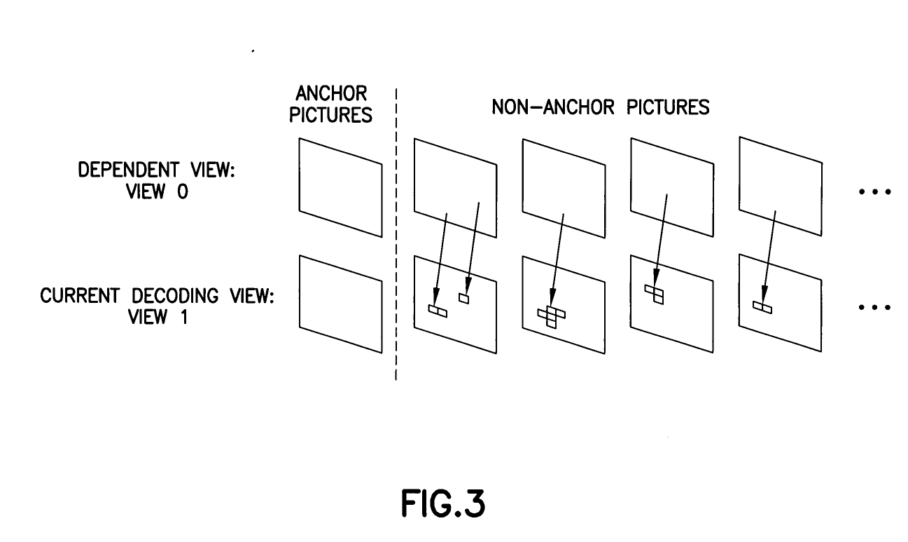

FIG. 4 is a representation showing the hierarchical macroblock partitioning arrangement used in conventional H.264/AVC based or compliant standards;

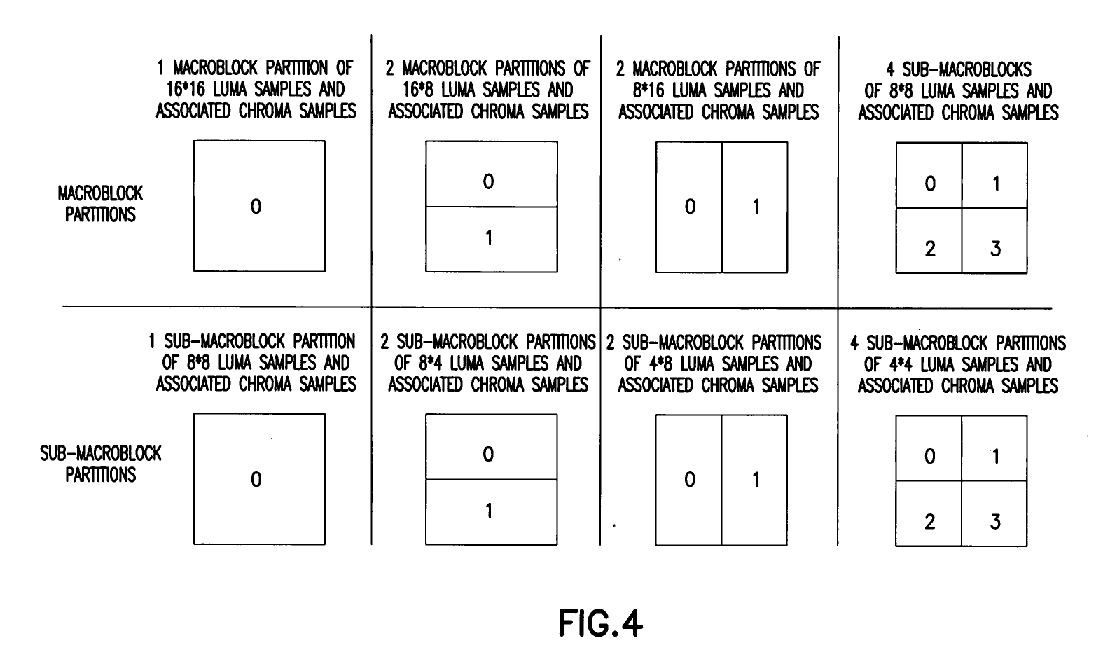

FIG. 5 is an example of a co-located 8×8 partition that is located in several MB partitions with different referencing statuses in the inter-view reference picture being considered for motion skip;

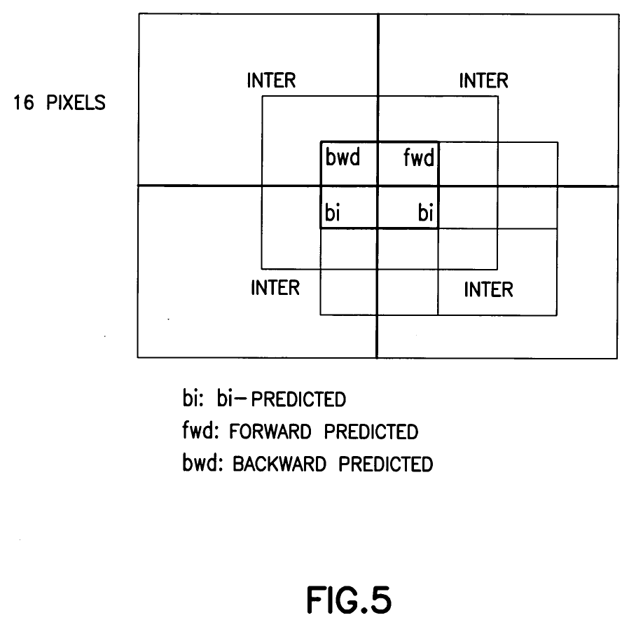

FIG. 6 is an example of a co-located partition that is located in several MB partitions with different referencing index values in the inter-view reference picture being considered for motion skip;

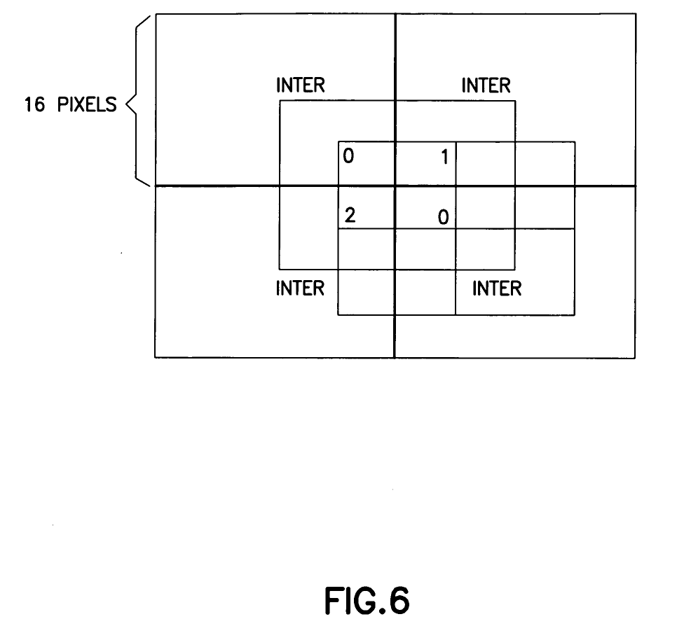

FIG. 7 is an example of a co-located 8×8 partition corresponding to pixels in an Intra MB of the inter-view reference picture being considered for motion skip;

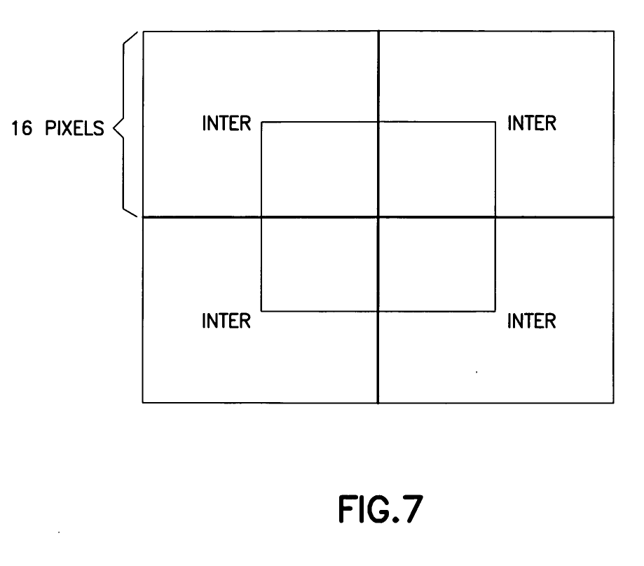

FIG. 8 is a representation of an 8×8 partition located within two 8×8 MB partitions;

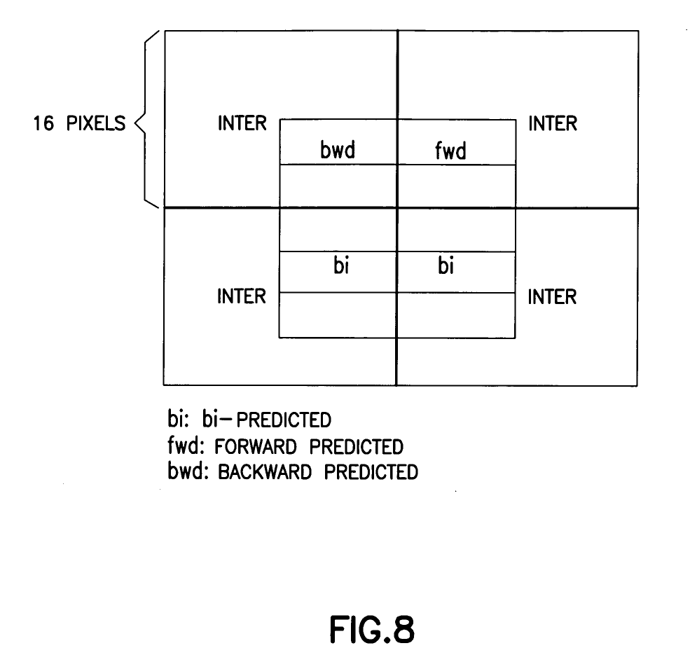

FIG. 9 is a graphical representation of a generic multimedia communication system within which various embodiments of the present invention may be implemented;

FIG. 10 is a flow chart showing the processes involved in an algorithm which is followed when there is one or more inter-view reference pictures according to various embodiments;

FIG. 11 is a graphical representation of motion vector scaling according to various embodiments;

FIG. 12(a) is a representation of four blocks in an illegal co-located MB partition and their classifications in term of zoom 1, zoom 2 and zoom 3; and FIG. 12(b) is a depiction of an individual block representative of the blocks in FIG. 12(a), along with the block's respective 4-neighboring blocks;

FIG. 13 is an example showing available motion information being predicted by two inter-view reference pictures;

FIG. 14 is a representation of motion disparity prediction from adjacent MB's (A, B, D and C);

FIG. 15 is a perspective view of an electronic device that can be used in conjunction with the implementation of various embodiments of the present invention; and

FIG. 16 is a schematic representation of the circuitry which may be included in the electronic device of FIG. 15.

### DETAILED DESCRIPTION OF VARIOUS EXEMPLARY EMBODIMENTS

Various exemplary embodiments of this invention relate to a system and method for implementing motion skip and single-loop decoding for multi-view video coding. In various exemplary embodiments a more efficient motion skip is used for the current JMVM arrangement by 8×8 or 4×4 pel disparity motion vector accuracy, while maintaining the motion compensation process that is compliant with the H.264/AVC design regarding hierarchical macroblock partitioning. This system and method is applicable to both multiple-loop decoding and single-loop decoding.

With regard to the above-identified issues with regard to 8-pel or 4-pel accuracy motion skip, adaptive referencing merging may be used in order achieve a more accurate motion skip from one inter-view reference picture. Such adaptive referencing merging is also applicable for multiple inter-view reference pictures. For the case where there are multiple inter-view reference pictures, and particularly inter-view reference pictures in different directions, a combined motion skip algorithm may be used.

With regard to the signaling issues noted previously, in order to indicate whether a picture is to be used for motion skip, a new syntax element or syntax modification in the NAL unit header may be used. In order to indicate whether a picture utilizes motion skip, a flag may be added in the slice header, and the related disparity motion vectors may be signaled in the slice header for each slice. Single loop decoding functionality for a bitstream may be signaled in the sequence level. Motion disparity for each MB or MB partition may also be signaled.

The use of various exemplary embodiments of this invention serves to improve coding efficiency when inter-view prediction between views is used, while also reducing the overall complexity when some views are not targeted for output. Additionally, various motion skip arrangements discussed herein can also be used for single-loop decoding, which does not apply motion compensation for those views that are only needed for inter-view prediction but not for output.

These and other advantages and features of the invention, together with the organization and manner of operation thereof, will become apparent from the following detailed description when taken in conjunction with the accompanying drawings, wherein like elements have like numerals throughout the several drawings described below.

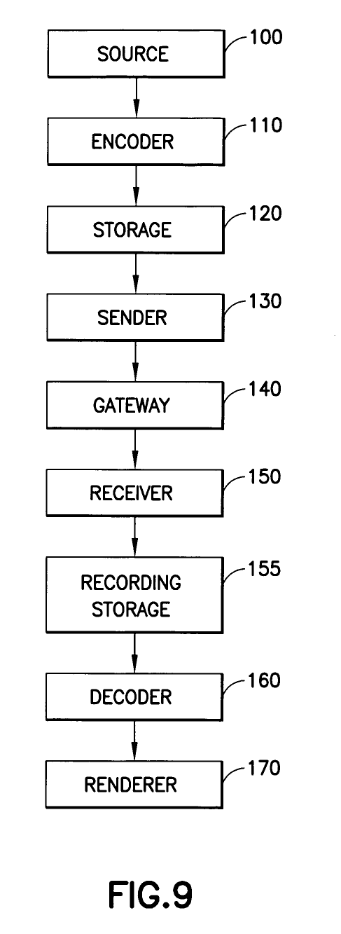

FIG. 9 is a graphical representation of a generic multimedia communication system within which various embodiments of the present invention may be implemented. As shown in FIG. 9, a data source 100 provides a source signal in an analog, uncompressed digital, or compressed digital format, or any combination of these formats. An encoder 110 encodes the source signal into a coded media bitstream. It should be noted that a bitstream to be decoded can be received directly or indirectly from a remote device located within virtually any type of network. Additionally, the bitstream can be received from local hardware or software. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 9 only one encoder 110 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the server 130 may reside in the same physical device or they may be included in separate devices. The encoder 110 and server 130 may operate with live real-time content, in which case the coded media bitstream is typically not stored permanently, but rather buffered for small periods of time in the content encoder 110 and/or in the server 130 to smooth out variations in processing delay, transfer delay, and coded media bitrate.

The server 130 sends the coded media bitstream using a communication protocol stack. The stack may include, but is not limited to, Real-Time Transport Protocol (RTP), User Datagram Protocol (UDP) and Internet Protocol (IP), as several non-limiting examples. When the communication protocol stack is packet-oriented, the server 130 encapsulates the coded media bitstream into packets. For example, when RTP is used, the server 130 encapsulates the coded media bitstream into RTP packets according to an RTP payload format. Typically, each media type has a dedicated RTP payload format. It should be again noted that a system may contain more than one server 130, but for the sake of simplicity, the following description only considers one server 130.

The server 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Several non-limiting examples of gateways 140 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is referred to as an RTP mixer or an RTP translator and typically acts as an endpoint of an RTP connection.

The system includes one or more receivers 150, typically capable of receiving, de-modulating, and de-capsulating the transmitted signal into a coded media bitstream. The coded media bitstream is transferred to a recording storage 155. The recording storage 155 may comprise any type of mass memory to store the coded media bitstream. The recording storage 155 may alternatively or additively comprise computation memory, such as random access memory. The format of the coded media bitstream in the recording storage 155 may be an elementary self-contained bitstream format, or one or more coded media bitstreams may be encapsulated into a container file. If there are many coded media bitstreams, such as an audio stream and a video stream, associated with each other, a container file is typically used and the receiver 150 comprises or is attached to a container file generator producing a container file from input streams. Some systems operate “live,” i.e. omit the recording storage 155 and transfer coded media bitstream from the receiver 150 directly to the decoder 160. In some systems, only the most recent part of the recorded stream, e.g., the most recent 10-minute excerption of the recorded stream, is maintained in the recording storage 155, while any earlier recorded data is discarded from the recording storage 155.

The coded media bitstream is transferred from the recording storage 155 to a decoder 160. If there are many coded media bitstreams, such as an audio stream and a video stream, associated with each other and encapsulated into a container file, a file parser (not shown in the figure) may be used to decapsulate each coded media bitstream from the container file. The recording storage 155 or a decoder 160 may comprise the file parser, or the file parser is attached to either recording storage 155 or the decoder 160.

The coded media bitstream is typically processed further by the decoder 160, whose output is one or more uncompressed media streams. Finally, a renderer 170 may reproduce the uncompressed media streams with a loudspeaker and/or a display, for example. The receiver 150, recording storage 155, decoder 160 and renderer 170 may reside in the same physical device, or they may be included in separate devices.

The sender 130 according to various exemplary embodiments of this invention may be configured to select the transmitted layers for multiple reasons, such as to respond to requests of the receiver 150 or prevailing conditions of the network over which the bitstream is conveyed. A request from the receiver 150 can be, e.g., a request for a change of layers for display or a change of a rendering device having different capabilities compared to the previous one.

The following is a description and discussion of an algorithm for making a co-located MB useable for motion skip when there is only one inter-view reference picture for motion skip. A number of new definitions and extensions to some notions defined earlier are provided below. This is followed by a non-limiting example of an algorithm that addresses at least the various issues discussed previously.

As has been discussed previously, a co-located MB partition in an inter-view reference picture may not obey the hierarchical macroblock partitioning and thus can not be directly used for motion skip. One such case involves the situation where one or more blocks are designated “use ListX”, while other blocks are designated “not use ListX”. As discussed herein a co-located MB partition is designated “use ListX” if all of its blocks are designated “use ListX” (with X being 0 or 1).

A co-located MB partition is defined to be legal if all of the following conditions are true: First, all blocks inside the MB partition are simultaneously “use List0” and “use List1”, or “use List0” and “not use List1”, or “not use List0” and “use List1”. A MB partition satisfying this is with “good reference”. Otherwise the MB partition is with “bad reference”. Second, if the MB partition is designated “use ListX”, then all blocks inside this MB partition simultaneously use the same reference picture listed in RefPicListX (with X being 0 or 1). It should be noted that if all of the blocks are within the same slice, or if all of the blocks are within slices that contain the same reference picture list reordering commands, if present, then all of the blocks using the same reference picture listed in RefPicListX are equivalent to all of the blocks using the same reference picture index in RefPicListX. If any of the above conditions are false, then a co-located MB partition is defined to be illegal. A MB is defined to be legal if all of its MB partitions are legal. Otherwise, the MB is defined to be illegal.

If the disparity vector and (0,0) is congruent modulo 2, i.e., the co-located MB partitions are aligned with the MB partition boundaries of the inter-view reference picture, each of these co-located MB partitions is by natural legal as long as it is located in an Inter MB in the inter-view reference picture. This is because any MB partition in the inter-view reference picture obeys the hierarchical macroblock partitioning.

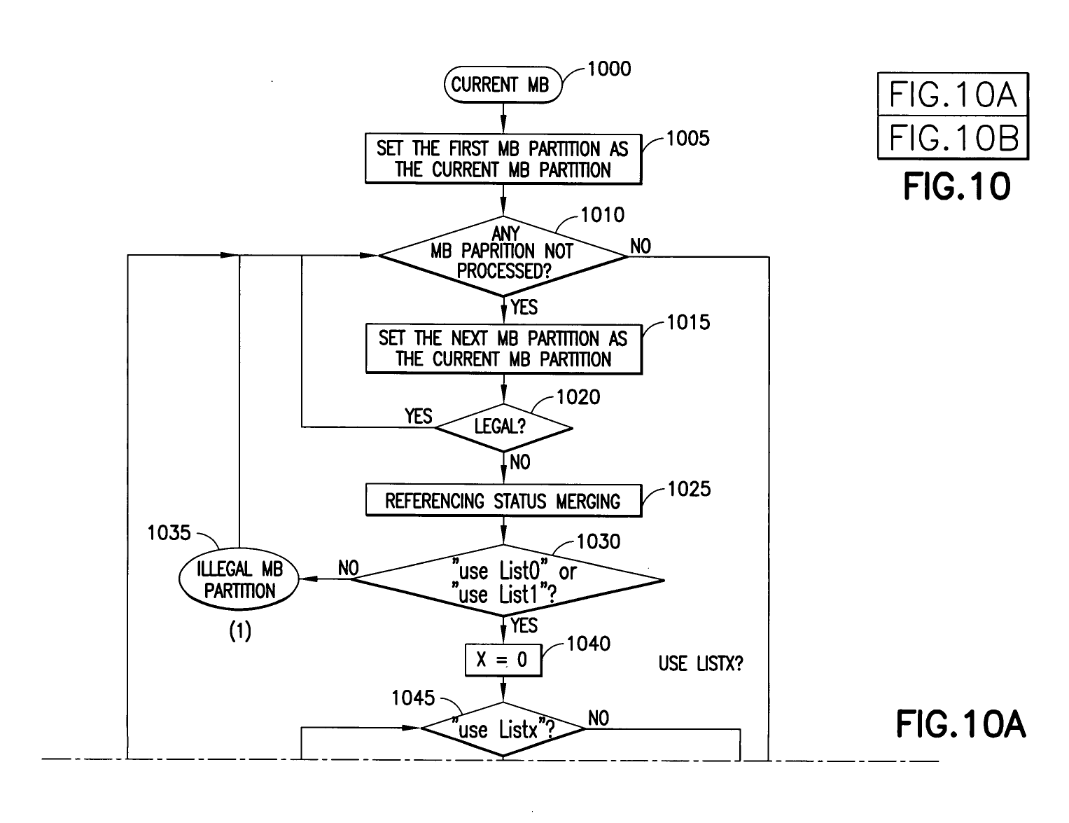

FIG. 10 is a flow chart showing the processes involved in an algorithm which is followed when there is one or more inter-view reference pictures according to various exemplary embodiments. When encoding a MB of the current picture and during the checking of the motion skip mode, after obtaining the co-located MB partitions using the disparity motion, the algorithm depicted in FIG. 10 is invoked.

The algorithm depicted in FIG. 10 leads to two kinds of exits: a legal MB exit or an illegal MB exit. A legal MB exit means that the motion skip mode is enabled for the current MB. An illegal MB exit means that the motion skip mode is not used for the current MB. For a MB, if the motion skip mode is enabled, whether the motion skip mode is finally used for encoding the MB depends on whether it is better than other coding modes in terms of coding efficiency. For a MB, if motion skip mode is used, then the generated motion information for this MB is used, directly or indirectly, for further motion compensation.

In the algorithm depicted in FIG. 10 a pair of procedures are involved. The first procedure begins from the point depicted at 1005 and ends before the point depicted at 1075 in FIG. 10. This procedure is referred to as MB partition motion merging. In MB partitioning motion merging, an illegal co-located MB partition can be turned to a legal co-located MB partition. The second procedure starts when the first procedure ends (as depicted at 1075) and ends at points depicted at 1072, 1085, 1100 or 1110. This second procedure is responsible for further turning an illegal co-located MB to a legal co-located MB and ends with either an illegal MB exit or a legal MB exit. This procedure is referred to as MB motion merging. During decoding, if a MB utilizes a motion skip mode, then the algorithm is applied similarly, with the exception that the possible exit is a legal MB exit. The generated motion information for this MB is used, directly or indirectly, for further motion compensation. In the MB partition motion merging procedure, co-located MB partitions are checked one by one. Each co-located MB partition is processed as follows. If the current co-located MB partition is legal, then no further process is needed in this procedure, and the next co-located MB partition is processed. Otherwise, if the current co-located MB partition is illegal, the following applies. If the current co-located MB partition is with “bad reference”, then the referencing status merging process is applied to repair the “bad reference” to “good reference”. If the referencing status merging process fails, then the co-located MB partition is left as illegal, and the next co-located MB partition is processed.

If the current co-located MB partition is with “good reference” (either the co-located MB partition was with “good reference” before the above process or was made with “good reference” by the above process), the following applies first for X being 0 and then for X being 1. If the current co-located MB partition is “use ListX”, then the reference index merging process and the motion vector generation and scaling process (described below) are invoked sequentially.

The reference index merging process guarantees that, after this process, blocks inside the current co-located MB partition use the same reference picture for inter prediction for each prediction direction. The motion vector generation and scaling process scales the motion vector(s) for the block(s) for which the reference picture in RefPicListX have been changed during the reference index merging process and generates motion vector(s) for the block(s) that was not associated with motion information for RefPicListX before the reference index merging process.

The MB motion merging procedure of the algorithm depicted in FIG. 10 tries to repair an illegal co-located MB to legal if only one co-located MB partition inside the current co-located MB is illegal. When processing the illegal co-located MB partition, its motion information (if present) is neglected. Instead, the motion information for this illegal co-located MB partition is generated by the MB motion merging procedure, which includes the prediction generation process and the motion vector generation process. For each value of X (being 0 or 1), the prediction generation process tries to set the illegal co-located MB partition to “use ListX”, and tries to set a reference index for this co-located MB partition. For each value of X (being 0 or 1), the motion vector generation process generates the motion vectors associated to the reference index for RefPicListX when the co-located MB partition “use ListX”. This description assumes that there is only one inter-view reference picture used. However, the algorithm of FIG. 10 can also be extended to the situation where multiple inter-view reference pictures are available, as described later herein.

The first procedure of MB partition motion merging tries to make illegal co-located MB partitions legal, and this procedure is applied to all of the four co-located MB partitions in the current co-located MB, one by one. If the co-located MB partition happens to cross the slice boundary of the inter-view reference picture, then a same reference index value in different blocks might not correspond to the same reference picture. In this case, the reference index (if available) in each block is mapped to its reference picture P first, and the reference index of the reference picture P is searched in the RefPicListX of the current picture. If an available reference index is found (denoted as idx), then the processes defined herein apply, as if the reference index of this block is idx for RefPicListX of the current picture. If no available reference index is found, then it is treated as “not use ListX”. If a co-located block or MB partition has a reference index referring to an inter-view reference picture in RefPicListX, it is also treated as “not use ListX”. The referencing status merging process, the reference index merging process, and the motion vector generation and scaling process of the MB partition motion merging procedure are described below.

The process of reference status merging attempts to turn a co-located MB partition with “bad reference” to be with “good reference”. Forward and backward prediction status, corresponding to “use List0” and “use List1” respectively, can be handled separately. The following is applied first for X being 0 and then for X being 1. Case 1 involves the situation where the disparity vector and (0,0) are congruent modulo 2. The co-located MB partition is in one MB partition of the inter-view reference picture. Merging is not needed. Case 2 involves the situation where the disparity vector and (1, 0) or (0, 1) are congruent modulo 2. The co-located MB partition is in two MB partitions of the inter-view reference picture. If both MB partitions “use ListX”, then the co-located MB partition is designated “use ListX”. Otherwise, the co-located MB partition is designated “not use ListX”. Case 3 involves the situation where the disparity vector and (1, 1) are congruent modulo 2. The co-located MB partition consists of four blocks in four MB partitions of the inter-view reference picture. If 3 or 4 of the blocks are designated “use ListX”, then the co-located MB partition is designated “use ListX”. Otherwise, the co-located MB partition is designated “not use ListX”. If the co-located MB partition is designated “use ListX”, then all its blocks are designated “use ListX”.

After referencing status merging, if the co-located MB partition is designated either “use List0” but “not use List1”, “use List1” but not “use List0”, or “use List0” and “use List1”, it is with “good reference”. The following processes (i.e., the reference index merging process and the motion vector generation and scaling process) are only applicable to MB partitions with “good reference”. In an another embodiment herein, the co-located MB partition may be set to be with “bad reference”, and further processing is stopped in this procedure for the co-located MB partition if it belongs to a B slice and is not bi-predicted, i.e. “not use List0” or “not use List1”.

If a co-located MB partition has been repaired to be with “good reference” during the referencing status merging process, it can be turned into a legal co-located MB partition by the reference index merging process. The reference index merging process applies when X being either 0 or 1.

Two rules are introduced for reference index merging. The first rule is to select the minimum reference index value. The second is to select the most frequently used reference index value from the blocks in this co-located MB partition. Other rules may also be implemented as necessary or desired.

The following solutions for Cases 1, 2 and 3 above are as follows. If the current co-located MB partition “use ListX”, the following applies. In the situation of Case 1 (where the disparity vector and (0, 0) are congruent modulo 2), the reference index merging process is skipped. In the situation of Case 2 (where the disparity vector and (1, 0) or (0, 1) are congruent modulo 2), the minimum reference index value of the two MB partitions in the inter-view reference picture are selected. In the situation of Case 3 (where the disparity vector and (1, 1) are congruent modulo 2), one of the following four solutions is applied. First, the minimum reference index value of the four blocks in the inter-view reference picture is selected. Second, the reference index value from the four blocks in the inter-view reference picture that corresponds to the reference picture being the closest to the current picture in the display order is selected. Third, the most frequently used reference index among the four blocks in the inter-view reference picture is selected. If there is more than one value that is most frequently used, the value with the smaller (smallest) reference index value is chosen. Fourth, the most frequently used reference index among the four blocks in the inter-view reference picture is selected. If there is more than one value that is most frequently used, then the value that corresponds to the reference picture being the closest to the current picture in the display order is chosen.

In view of the above, the possible different reference indices for the four blocks referring to pictures in RefPicListX can be united to one reference index. The final reference index value for the co-located MB partition is referred to as the united reference index, and the corresponding reference picture is referred to as the united reference picture.

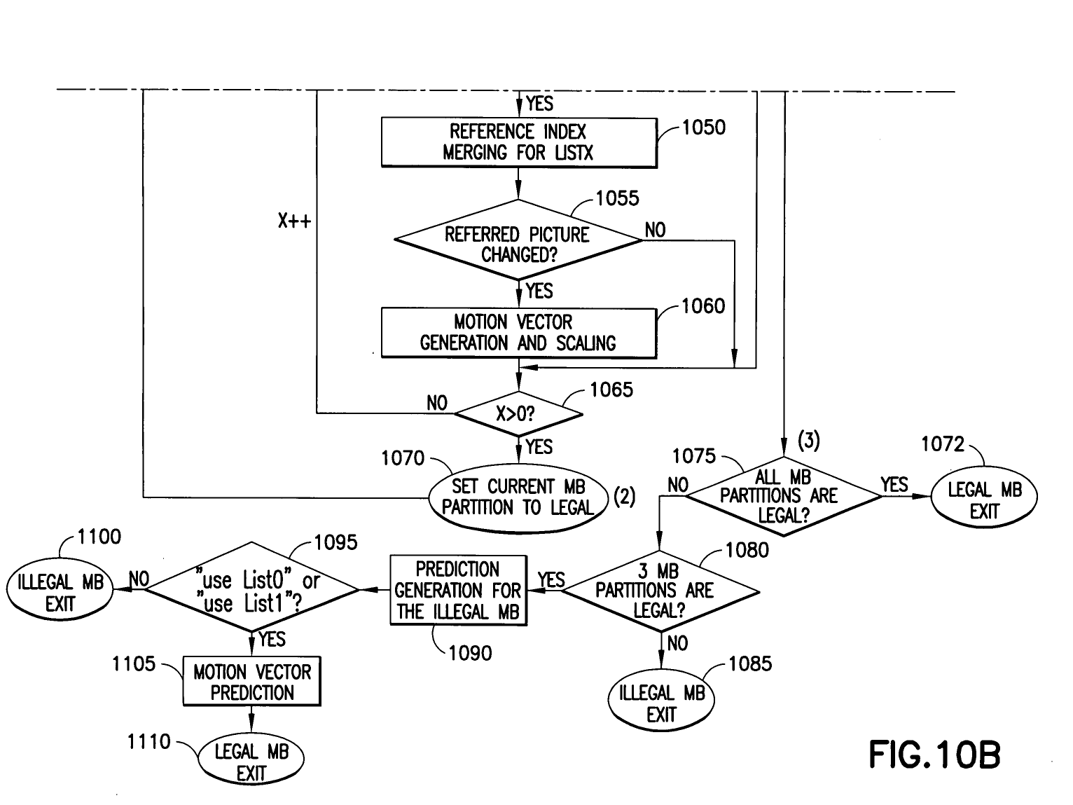

The motion vector scaling and generation process, which is graphically represented in FIG. 11, applies when X is either 0 or 1, and the process applies to all of the four blocks in the current co-located MB partition, one by one. For a block in a co-located MB partition, any of the following cases is possible. In the first case, the block was designated “use ListX” before referencing status merging and the reference index value has not been modified during reference index merging. In the second case, the block was designated “use ListX” before referencing status merging, but its reference index value has been modified during reference index merging. In the third case, the block was designated “not use ListX”, but it has been turned to “use ListX” and a reference index has been assigned for it during reference index merging.

In the first case discussed above, motion vector scaling and generation is not needed. In the second case, the motion vector is scaled according to the equation mv′=td*mv/to, wherein and referring again to FIG. 11, mv is the original motion vector, mv′ is the scaled motion vector, td is the distance between the current picture and the united reference picture, and to is the distance between the current picture and the original (previous) reference picture. Both td and to are in units of PicOrderCnt difference, where PicOrderCnt indicates the output order (i.e. display order) of pictures as specified in H.264/AVC. In the third case discussed above, the motion vectors are generated as follows. According to the referencing status merging process, for RefPicListX, at most one block in a co-located MB partition can be “not use ListX” if the MB partitions has been turned to “use ListX”. Therefore, the co-located MB partition contains at most one block that belong to this third case. The reference index of this block was set to the united reference index. The motion vector for the block referring to a picture in RefPicListX is generated by either of the following two methods:

1. Using the median operation from the three motion vectors in the other blocks. If any of the 3 motion vectors has been scaled, then the scaled motion vector is used in the median operation. The motion vector of the block is then set to be the median value of the three motion vectors.
2. Use the motion vectors that have not been scaled. If only one motion vector has not been scaled, then this motion vector is used as the motion vector of the block. If two motion vectors of two blocks have not been scaled, then the average of these two motion vectors is used as the motion vector of the block. In other cases (i.e., if none of the motion vectors have been scaled), then the median operation in the first method is used.

It should be noted that, for the third case discussed above, for at most two blocks in the co-located MB partition, the motion vectors could be scaled due to the change of the referred picture(s) during the reference index merging process.

The second procedure of the algorithm, i.e., MB motion merging, may turn an illegal co-located MB with only one illegal co-located MB partition to a legal co-located MB. During this procedure, the illegal co-located MB partition's motion information, if present, is neglected. In the beginning of this procedure, the illegal co-located MB is set to “not use List0” and “not use List1”. This procedure contains two main processes, prediction generation and motion vector generation.

The prediction generation process tries to make the illegal co-located MB partition from “not use List0” and “not use List1” to “use List0” or “use List1” or both.

The following applies first for X being 0 then for X being 1. If the other three co-located MB partitions are designated “use ListX”, then the illegal co-located MB partition is set as “use ListX”, and a reference index is selected for the co-located MB partition based on either of the following rules: (1) Selecting the minimum reference index value from the other 3 co-located MB partitions. (2) Selecting the most frequently used reference index value from the other three co-located MB partitions. In (2), if there is more than one value that is most frequently used, the value with the smaller (smallest) reference index value is chosen.

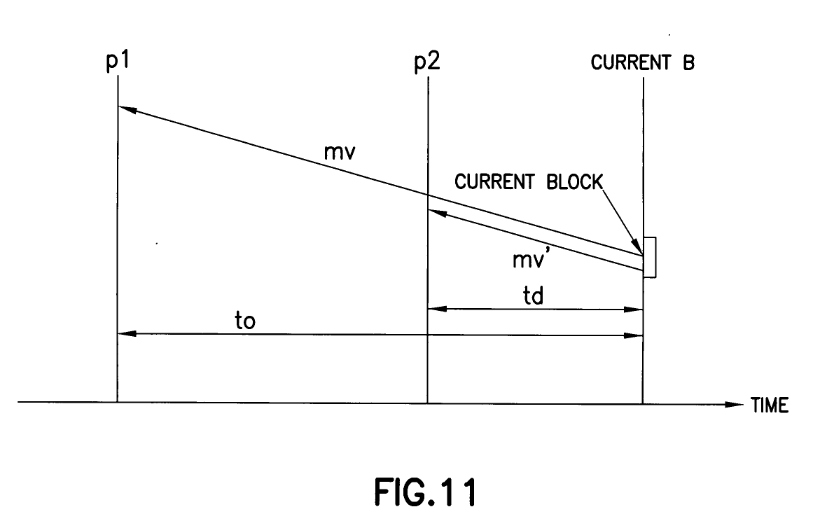

The motion vector generation process generates four motion vectors for the four blocks in the illegal co-located MB partition, according to the motion vectors in the other three co-located MB partitions. The following applies first for X being 0 then for X being 1. Among the other three co-located MB partitions, only the motion vectors of those that are with the same reference index as the illegal co-located MB partition are considered in the following. The four blocks in the illegal co-located MB partition are classified to 3 types: (1) zoom 1, the block that is closest to the center of the co-located MB; (2) zoom 3, the block that is farthest to the center of the co-located MB; and (3) zoom 2, the other two blocks, as shown in FIG. 12(a). For each block, the blocks to the left, to the right, above and below, as shown in FIG. 12(b), are referred to as 4-neighboring blocks. The motion vectors for the four blocks in the illegal co-located MB partition are generated by the following.

1. For the block in zoom 1, it has two 4-neighboring blocks in other co-located MB partitions in the co-located MB. These two 4-neighboring blocks are referred to as candidate blocks 1 and 2. The third candidate block in other co-located MB partitions is the block that is the 4-neighboring block of both candidate blocks 1 and 2. For the three candidate blocks, the motion vectors of the ones that have the same reference index value as the illegal co-located MB partition (generated by the prediction generation process) are used to generate the motion vector of the block in zoom 1. If only one of the three candidate blocks is qualified, then the motion vector of that block is copied as the motion vector of the block in zoom 1. If two of the three candidate blocks are qualified, then the motion vector of the block in zoom 1 is set to average of the motion vectors of the two blocks. If all the three candidate blocks are qualified, then the motion vector of the block in zoom 1 is set to the median of the three motion vectors of the three candidate blocks.
2. For a block in zoom 2, it has one 4-neighboring block in other co-located MB partitions. This 4-neighboring block is the only candidate block. If the candidate block has the same reference index as the illegal co-located MB partition, the motion vector of the block in zoom 2 is set to the motion vector of the candidate block. Otherwise, the motion vector of the block in zoom 2 is set to the motion vector of the block in zoom 1.
3. Repeat process (2) for the other block in zoom 2.
4. For the block in zoom 3, it has no 4-neighboring block in other co-located MB partitions in the co-located MB. If, in processes (2) or (3), the candidate block had different reference index as the illegal co-located MB partition, then the motion vector of the block in zoom 3 is set to the motion vector of the block in zoom 1. Otherwise, the motion vector of this block is set to the median of the 3 motion vectors of the 3 blocks in the same co-located MB partition.

As mentioned above, FIG. 10 is a flow chart showing the processes involved in an algorithm which is followed when there is one or more inter-view reference pictures according to various embodiments. FIG. 10 is discussed in detail herein. The algorithm begins with a current MB at 1000. At 1005, the first MB partition is set as the current MB partition. At 1010, it is determined whether a MB partition has yet to be processed. If a MB partition still has to be processed, then the next MB partition to be processed is set as the current MB partition at 1015. At 1020, it is determined if the current MB partition is legal. If so, then the process refers back to 1010. If not, then reference status merging occurs at 1025, after which it is determined at 1030 whether the all blocks within the current MB partition is identified as “useList0”, “useList1” or both “useList0” and “useList1”. If not, then at 1035 the current MB partition is identified as an illegal MB partition and returns to 1010. If so, however, then at 1040 x is set to 0 and, at 1045, it is determined whether the current MB partition is identified as “use Listx”. If so, the reference index merging for listx occurs at 1050. At 1055, it is determined whether the reference picture has changed. If so, then at 1060, motion vector generation and scaling occurs, and it is determined at 1065 whether x is greater than zero. If x is not greater than zero, then the process returns to 1045. If x is greater than zero, then the current MB partition is set to legal at 1070 and the process returns to 1010. It should also be noted that if the answer to the determination at either blocks 1045 and 1055 is “no,” then the process jumps to 1065.

Referring again to 1010 in FIG. 10, if there are no MB partitions still to be processes, then at 1072 it is determined whether all MB partitions are legal. If all MB partitions are legal, then the process ends at 1075 with a legal MB exit. If not, however, it is determined at 1080 whether three MB partitions are legal. If not, then the process ends with an illegal MB exit at 1085. If there are three MB partitions, then prediction generation occurs for the illegal MB at 1090. It is then determined at 1095 whether all blocks in the illegal MB partition are identified as “use List0” or “useList1”. If not, then the process ends with an illegal MB exit at 1100. If so, however, then motion vector prediction occurs at 1105 and the process ends with a legal MB exit at 1110.

Where there is more than one inter-view reference picture, any of the inter-view reference pictures can be selected for motion skip when encoding a slice. Alternative methods for the selection are described below. When only one inter-view reference picture is used for motion skip, the co-located MB containing the MB mode and motion vectors to be used to predict the current MB are from the one inter-view reference picture. As the co-located MB may have been changed by the algorithm discussed above and depicted in FIG. 10, the final co-located MB is referred to as the predictor MB.

It should be noted that the various blocks shown in FIG. 10 may be viewed as method steps, and/or as operations that result from operation of computer program code, and/or as a plurality of coupled logic circuit elements constructed to carry out the associated function(s).

The following is a more detailed discussion regarding the selection of an inter-view reference picture for motion skip.

For each slice, the inter-view reference picture used for motion skip is either derived or signaled. Therefore, the picture used for motion skip may be different from the first inter-view reference picture signaled in the view dependency, and it can be any inter-view reference picture. For example, the first inter-view reference picture signaled in the view dependency information corresponding to RefPicList0 is selected to be the inter-view reference picture used for motion skip. As another example, the first inter-view reference picture in RefPicList0 is selected. It should be noted that RPLR commands can make any inter-view reference picture the first one in RefPicList0.

As an alternative to the above, when the current picture has backward inter-view reference pictures, in the above two methods, RefPicList0 is replaced with RefPicList1. In another alternative, when the current picture has both forward and backward inter-view reference pictures, the above methods can be applied to select two inter-view reference pictures, corresponding to RefPicList0 and RefPicList1, respectively, and a flag is signaled to select one of the two selected inter-view reference pictures. Alternatively still, the used inter-view reference picture can be explicitly signaled, e.g., by inclusion the index of the view identifier appeared in the view dependency and a flag indicating whether it is forward or backward inter-view reference picture, in the slice header. Alternatively still, the view identifier of the view used for motion skip can also be included in the slice header.

The method described above is used for selection of one inter-view reference picture from multiple available inter-view reference pictures for use in motion skip. When there is more than one inter-view reference picture available, it is also possible that, for each MB to be encoded, more than one inter-view reference picture is used for motion skip. In this case, the current MB has a co-located MB in each used inter-view reference picture according to the disparity motion between the current picture and the inter-view reference picture. Each of these co-located MBs is referred to as a candidate co-located MB for generation of the predictor MB, and the predictor MB is generated from all the candidate co-located MBs. Solutions for the generation of the predictor MB for motion skip with multiple inter-view reference pictures are presented below. These solutions are also referred to as combined motion skip algorithms.

First, each predictor MB partition of a predictor MB is selected from the candidate co-located MB partitions. This is referred to as reference combination. After reference combination, the second procedure in the algorithm discussed above and depicted in FIG. 10 is applied to the four predictor MB partitions.

In reference combination, to select a predictor MB partition from the candidate co-located MB partitions, the candidate co-located MB partitions are considered in a pre-determined order, e.g., first forward dependent view(s) and then backward dependent view(s). For inter-view reference pictures in each reference picture list, the order is the same as in the reference picture list or the same as in the sequence parameter set MVC extension. Based on the order, if a co-located MB partition in an inter-view reference picture is found to be legal, then the first procedure in the algorithm discussed above and depicted in FIG. 10 is applied for this co-located MB partition, and this co-located MB partition is selected as the predictor MB partition, without further considering the candidate co-located MB partitions from the rest of the inter-view reference pictures.

If there is no legal co-located MB partition in any of the inter-view reference pictures, the following applies. In the same order as above, the candidate co-located MB partitions are searched for the first co-located MB partition with “good reference”. If found, the first candidate co-located MB partition with “good reference” is selected as the predictor MB partition, without further considering the rest of the candidate co-located MB partitions. The reference index merging process and the motion vector generation and scaling process are then applied to the predictor MB partition. If no co-located MB partition with “good reference” is found, then the referencing status merging process is applied to the candidate co-located MB partitions in the order as above. Whenever the referencing status merging process for a candidate co-located MB partition succeeds, the repaired candidate co-located MB partition with “good reference” is selected as the predictor MB partition, without further considering the rest of the candidate co-located MB partitions. The reference index merging process and the motion vector generation and scaling process are then applied to the predictor MB partition. If the referencing status merging process fails for all of the candidate co-located MB partitions, the predictor MB partition is illegal.

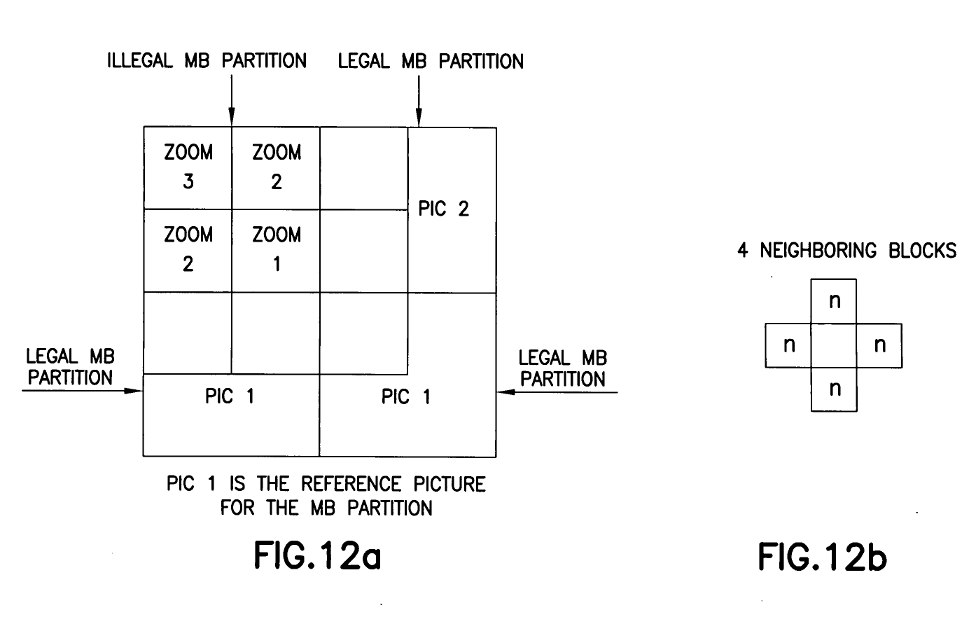

An example of the reference combination is shown in FIG. 13 where both the forward inter-view reference picture (the inter-view reference picture to the left) and the backward inter-view reference picture (the inter-view reference picture to the right) contain only P slices. The disparity vector between the current picture and the forward inter-view reference picture and (0, 0) are congruent modulo 2, and the disparity motion between the current picture and the backward inter-view reference picture and (1, 1) are congruent modulo 2. For the top-left predictor MB partition, the candidate co-located MB partition from the forward inter-view reference picture falls into an Inter MB, so it is legal and selected as the predictor MB partition. The procedure 1 for this top-left predictor MB partition is therefore accomplished. The same procedure is applied for the top-right predictor MB partition and the bottom-right predictor MB partition. For the bottom-left predictor MB partition, the candidate co-located MB partition from the forward inter-view reference picture falls into an Intra MB and thus is illegal. Therefore, the next candidate co-located MB partition from the backward inter-view reference picture is checked. This candidate co-located MB partition falls into an Inter MB, so it is legal and is selected as the predictor MB partition. The procedure 1 for this bottom left predictor MB partition is therefore accomplished. Therefore in this example, a legal predictor MB is generated, which has three legal predictor MB partitions from the forward inter-view reference picture and one legal predictor MB partition from the backward inter-view reference picture.

In reference combination, the inter-view reference picture from which a predictor MB partition comes from is derived as specified previously. In the following alternative solution, the inter-view reference picture used for motion skip is explicitly signaled for each MB or MB partition. In this alternative solution, for each MB, when motion skip is enabled, the view used for motion skip is also signaled. Therefore, the motion skip algorithm can adaptively select the inter-view reference picture, from which the motion vector of the current MB is derived. In this MB adaptive selection case, in the encoder, the two procedures of the algorithm depicted in FIG. 10 are applied separately for each co-located MB, and the procedure that leads to the best rate distortion performance is finally selected and the necessary information to identify this inter-view reference picture is signaled for the current MB which is being coded. In the decoder, when motion skip is the mode for the current MB, the information indicating which inter-view reference picture is used are read and the co-located MB is found. The first and second procedures for the algorithm depicted in FIG. 10 are then invoked. The above is at the MB level but can also be extended to MB partition level.

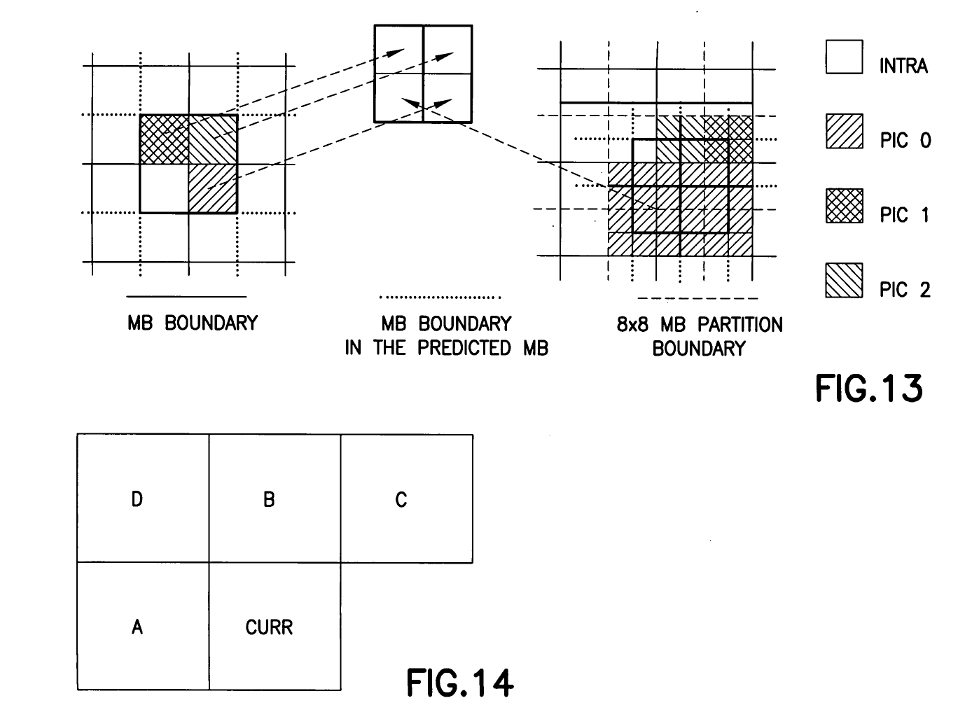

Besides using global disparity motion for a picture, adaptive disparity motion in a MB or a MB partition level can also be used. In various embodiments, the local disparity is coded relative to a signaled global disparity motion. The local disparity motion is signaled when the current MB uses motion skip mode. The coding of local disparity motion is similar to the predictive coding of motion vectors. As shown in FIG. 14, for the current MB (Curr MB), a median disparity motion is predicted from the top MB (B), the left MB (A) and the top-left MB (D). If D is not available, then the top-right MB (C) is used. In other cases, if a MB does not have the local motion disparity signaled, then the local disparity motion is inferred to be equal to the global disparity motion, to be used in predicting of local disparity motion for neighboring MBs.

At the encoder, the desired disparity can be generated by typical motion estimation and then quantized to 16-pel, 8-pel or 4-pel accuracy, depending on which accuracy is in use. Another embodiment involves refining the disparity motion prediction by searching areas around the disparity motion predictor. After the predictor and the desired disparity are generated, the difference between the disparity motion and the predictor is coded in a way similar to motion vector difference coding in H.264/AVC.

Motion skip can derive motion for the current MB. However, the derived motion may be not sufficiently accurate. In this situation, the motion vector accuracy can be further improved by refinement, e.g. by signaling a difference between the derived motion vector and the optimal (desired) motion vector.

In order to address various issues related to motion skip signaling, various embodiments are provided. In one embodiment, an indicator, in the form of a flag in one embodiment, is used to specify whether the current picture is used by any picture in other views for motion skip. Alternatively, the inter_view_flag is changed to inter_view_idc, which includes two bits. The first bit is equivalent to the original inter_view_flag, and the second bit is equivalent to the newly introduced flag.

An indicator, in the form of a flag in one embodiment, can also be provided in the slice header in order to indicate whether a slice is using motion skip or not. If not, then the motion skip flag for all the macroblocks in the current slice is not signaled and are inferred to be false. If this flag is true, then the motion disparity is signaled.

Still another indicator, in the form of a flag in one embodiment, may be used for each view in the sequence level, e.g., sequence parameter set MVC extension, to indicate whether it can be decoded by single loop decoding. Moreover, a flag or other indicator may be added for each view in the sequence level, e.g., sequence parameter set MVC extension, to indicate whether a view is required for any of other views for motion skip and another flag or other indicator to indicate whether a view is required for any of the other views for traditional inter-view sample prediction.

The following is example signaling which may be used in the various implementations discussed above. However, it should be noted that this signaling is only exemplary in nature, and one skilled in the art would understand that other signaling is possible.

To signal a picture used for motion skip, NAL unit header SVC MVC extension syntax may be as follows.

| | | |
|---|---|---|
| nal_unit_header_svc_mvc_extension( ) { | C | Descriptor |

| | | |
|---|---|---|
| svc_mvc_flag | All | u(1) |
| if (!svc_mvc_flag) { | | |

| | | |
|---|---|---|
| ... | All | u(3) |

} else {

| | | |
|---|---|---|
| priority_id | All | u(6) |
| temporal_id | All | u(3) |
| anchor_pic_flag | All | u(1) |
| view_id | All | u(10) |
| idr_flag | All | u(1) |
| inter_view_idc | All | u(2) |

}
nalUnitHeaderBytes += 3

}

The semantics of the syntax element inter_view_idc in the above NAL unit header SVC MVC extension syntax is as follows. When inter_view_idc is equal to 0, this specifies that the coded picture containing the current NAL unit is neither used as an inter-view prediction reference for sample prediction nor for motion skip. When inter_view_idc is equal to 1, this specifies that the coded picture containing the current NAL unit may be used for motion skip but never for inter-view sample prediction. When inter_view_idc is equal to 2, this specifies that the coded picture containing the current NAL unit may be used for inter-view sample prediction but never for motion skip. When inter_view_idc is equal to 3, this specifies that the coded picture containing the current NAL unit may be used for both inter-view sample prediction and motion skip.

The following is one possible arrangement for signaling the slice header flag to control whether a slice supports motion skip. In this arrangement, the slice header syntax is as follows:

| slice_header( ) { | | C | Descriptor |
|---|---|---|---|
| | first_mb_in_slice | 2 | ue(v) |
| | slice_type | 2 | ue(v) |
| | ic_enable | 2 | u(1) |
| | motion_skip_enable | 2 | u(1) |
| | if (motion_skip_enable) { | | |
| | ... | | |

for( compIdx = 0; compIdx < 2; compIdx++ )

| | | |
|---|---|---|
| global_disparity_mb_l1 [ compIdx ] | 2 | se(v) |

| } | | |
|---|---|---|
| pic_parameter_set_id | 2 | ue(v) |
| frame_num | 2 | u(v) |
| ... | | |

}

When motion_skip enable is equal to 0, this specifies that the current slice does not use motion skip. When motion_skip_enable is equal to 1, this specifies that the current slice uses motion skip.

For the signaling of the slice header flag as discussed above, sample macroblock layer syntax is as follows:

| | | | De- |
|---|---|---|---|
| macroblock_layer( ) { | | C | scriptor |
| | if ( ! anchor_pic flag &&motion_skip_enable) { | | |
| | motion_skip_flag | 2 | u(1) \| |

ae(v)

}

if (motion_skip_flag) {

...
}

}

In addition to the above, it may be necessary to signal multiple inter-view reference pictures, particularly for the case where one inter-view reference picture is used for each direction. In such a case, sample syntax is as follows:

if (motion_skip_flag) {

if ( MotionSKIPFwd &&MotionSKIPBwd)
{

| | | |
|---|---|---|
| fwdbwd_flag | 2 | u(1) \| |

ae(v)

}

...
}

MotionSKIPFwd is inferred to be 1 if num_non_anchor_refs_l0[i] (i has the value such that view_id[i] in the SPS MVC extension is the view identifier of the current view) in the referred SPS MVC extension is greater than 0. Otherwise, it is inferred to be 0. MotionSKIPBwd is inferred to be 1 if num_non_anchor_refs_l1[i] (i has the value such that view_id[i] in the SPS MVC extension is the view identifier of the current view) in the referred SPS MVC extension is greater than 0. Otherwise, it is inferred to be 0. When fwdbwd_flag is equal to 0, this specifies that the current MB uses the first forward inter-view reference picture for motion skip. When fwdbwd_flag is equal to 1, this specifies that the current MB uses the first backward inter-view reference picture for motion skip.

Example sequence-level signaling for single loop decoding is as follows:

| | | |
|---|---|---|
| | | De- |
| | | scrip- |
| seq_parameter_set_mvc_extension( ) { | C | tor |

| | |
|---|---|
| num_views_minus_1 | ue(v) |
| for(i = 0; i <= num_views_minus_1; i++) { | |

| | |
|---|---|
| view_id[i] | ue(v) |
| sld_flag[i] | u(1) |
| recon_sample_flag[i] | u(1) |
| recon_motion_flag[i] | u(1) |

}
for(i = 0; i <= num_views_minus_1; i++) {

| | |
|---|---|
| num_anchor_refs_l0[i] | ue(v) |
| for( j = 0; j < num_anchor_refs_l0[i]; j++ ) | |

| | |
|---|---|
| anchor_ref_l0[i][j] | ue(v) |

| | |
|---|---|
| num_anchor_refs_l1[i] | ue(v) |
| for( j = 0; j <num_anchor_refs_l1[i]; j++) | |

| | |
|---|---|
| anchor_ref_l1[i][j] | ue(v) |

}
for(i = 0; i <= num_views_minus_1; i++) {

| | |
|---|---|
| num_non_anchor_refs_l0[i] | ue(v) |
| for( j = 0; j < num_non_anchor_refs_l0[i]; j++) | |

| | |
|---|---|
| non_anchor_ref_l0[i][j] | ue(v) |

| | |
|---|---|
| num_non_anchor_refs_l1[i] | ue(v) |
| for(j = 0; j < num_non_anchor_refs_l1[i]; j++) | |

| | |
|---|---|
| non_anchor_ref_l1[i][j] | ue(v) |

}

}

When sld_flag[i] is equal to 1, this specifies that the view with view_id equal to view_id[i] supports single-loop decoding, i.e., any non-anchor picture referring to the sequence parameter set and with view_id equal to view_id[i] does not use inter-view sample prediction in the decoding process. When sld_flag[i] is equal to 0, this specifies that the view with view_id equal to view_id[i] does not support single-loop decoding, i.e. at least one non-anchor picture referring to the sequence parameter set and with view_id equal to view_id[i] uses inter-view sample prediction in the decoding process. When recon_sample_flag[i] is equal to 1, this specifies that at least one coded picture referring to the sequence parameter set and in the view with view_id equal to view_id[i] is used for inter-view sample prediction by at least one of the other views. When recon_sample_flag[i] is equal to 0, this specifies that none of the coded pictures referring to the sequence parameter set and with view_id equal to view_id[i] is used by any view for inter-view sample prediction. When recon_motion_flag[i] is equal to 1, this specifies that at least one coded picture referring to the sequence parameter set and in the view with view_id equal to view_id[i] is used for motion skip by at least one of the other views. When recon_motion_flag[i] is equal to 0, this specifies that none of the coded pictures referring to the sequence parameter set and with view_id equal to view_id[i] is used by any view for motion skip.

Communication devices according to various embodiments discussed herein may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

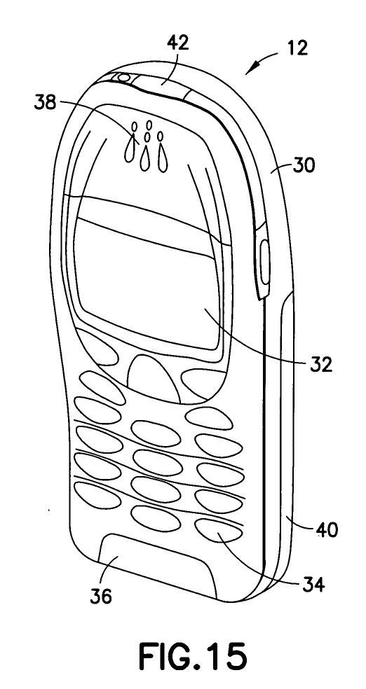

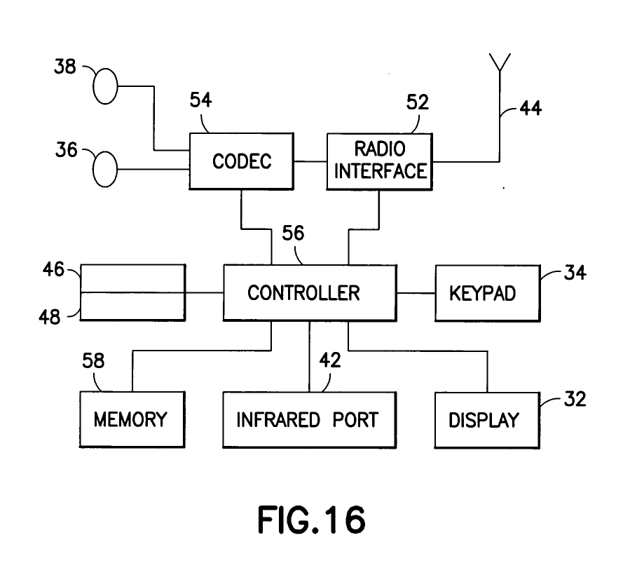

FIGS. 15 and 16 show one representative mobile device 12 within which the present invention may be implemented. It should be understood, however, that the present invention is not intended to be limited to one particular type of electronic device. Some or all of the features depicted in the mobile device may be incorporated into any or all of the devices discussed herein. The mobile device 12 of FIGS. 15 and 16 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, at least one controller 56 and a computer-readable memory medium, referred to for convenience as a memory 58. The memory 58 stores data, including computer program instructions that when executed by the at least one controller 56 enable the device 12 to operate in accordance with the exemplary embodiments of this invention. Individual circuits and elements may all be of a type well known in the art.

The various embodiments described herein are described in the general context of method steps or processes, which may be implemented in at least one embodiment by a computer program product, embodied in a computer-readable medium such as the memory 58, including computer-executable instructions, such as program code, embodied in a computer-readable medium such as the memory 58 and executed by one or more computers, possibly in a networked environment. Generally, program modules may include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the invention may be practiced in various components such as integrated circuits, such as integrated circuit chips and modules, and that the exemplary embodiments of this invention may be realized in an apparatus that is embodied as at least one integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention, as well as a computer readable memory medium that stores program instructions.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., motion_skip_enable, fwdbwd_flag, etc.) are not intended to be limiting in any respect, as these parameters may be identified by any suitable names. Further, any formulas and/or expressions that use these various parameters may differ from those expressly disclosed herein. Further, the various names assigned to different units and modules are not intended to be limiting in any respect, as these various units and modules may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
encoding a first sequence of input pictures and a second sequence of input pictures into a bitstream, where a first input picture of the first sequence of input pictures may or may not be intended for output, and where a second input picture of the second sequence of input pictures is intended for output;
including a disparity signal indication indicative of a disparity motion;
using a motion derivation method to derive at least one motion vector from the first input picture according to the disparity motion; and
using the at least one derived motion vector in encoding the second input picture.

2. The method of claim 1, wherein the disparity motion is of 8-pel accuracy.

3. The method of claim 1, wherein during deriving the at least one motion vector, a referencing status of one of forward predicted, backward predicted, and bi-predicted of at least one block in the first input picture has been changed.

4. The method of claim 1, wherein during deriving the at least one motion vector, a reference index of at least one block in the first input picture has been changed.

5. The method of claim 1, wherein during deriving the at least one motion vector, a reference index of at least one block in the first input picture has been generated.

6. The method of claim 1, wherein during deriving the at least one motion vector, a motion vector of at least one block in the first input picture has been changed.

7. The method of claim 1, wherein during deriving the at least one motion vector, a motion vector of at least one block in the first input picture has been generated.

8. The method of claim 1, wherein the disparity signal indication is included in the bitstream for one of a picture, a slice, a macroblock, and a macroblock partition.

9. The method of claim 1, wherein an indication is included in the bitstream, the indication being indicative of whether a picture is used in the deriving of the at least one motion vector.

10. The method of claim 1, wherein an indication is included in the bitstream, the indication being indicative of whether a view uses any other view for inter-view sample prediction.

11. The method of claim 1, wherein an indication is included in the bitstream, the indication being indicative of whether single-loop decoding is supported for a view.

12. The method of claim 1, wherein the at least one derived motion vector is refined such that a motion vector difference between the at least one derived motion vector and a desired motion vector is signalled for one of a macroblock and a macroblock partition.

13. The method of claim 1, wherein the disparity motion is of 4-pel accuracy.

14. A computer readable medium comprising computer code configured to perform the processes of claim 1.

15. An apparatus, comprising:
a processor; and
a memory unit communicatively connected to the processor and including:
computer code configured to encode a first sequence of input pictures and a second sequence of input pictures into a bitstream, wherein a first input picture of the first sequence of input pictures may or may not be intended for output, and wherein a second input picture of the second sequence of input pictures is intended for out;
computer code configured to include a disparity signal indication indicative of a disparity motion;
computer code configured to use a motion derivation method to derive at least one motion vector from the first input picture according to the disparity motion; and
computer code configured to use the at least one derived motion vector in encoding the second input picture.

16. The apparatus of claim 15, wherein the disparity motion is of 8-pel accuracy.

17. The apparatus of claim 15, wherein during deriving the at least one motion vector, a referencing status of one of forward predicted, backward predicted, and bi-predicted of at least one block in the first input picture has been changed.

18. The apparatus of claim 15, wherein during deriving the at least one motion vector, a reference index of at least one block in the first input picture has been changed.

19. The apparatus of claim 15, wherein during deriving the at least one motion vector, a reference index of at least one block in the first input picture has been generated.

20. The apparatus of claim 15, wherein during deriving the at least one motion vector, a motion vector of at least one block in the first input picture has been changed.

21. The apparatus of claim 15, wherein during deriving the at least one motion vector, a motion vector of at least one block in the first input picture has been generated.

22. The apparatus of claim 15, wherein the disparity signal indication is included in the bitstream for one of a picture, a slice, a macroblock, and a macroblock partition.

23. The apparatus of claim 15, wherein an indication is included in the bitstream, the indication being indicative of whether a picture is used in the deriving of the at least one motion vector.

24. The apparatus of claim 15, wherein an indication is included in the bitstream, the indication being indicative of whether a view uses any other view for inter-view sample prediction.

25. The apparatus of claim 15, wherein an indication is included in the bitstream, the indication being indicative of whether single-loop decoding is supported for a view.

26. The apparatus of claim 15, wherein the at least one derived motion vector is refined such that a motion vector difference between the at least one derived motion vector and a desired motion vector is signalled for one of a macroblock and a macroblock partition.

27. The apparatus of claim 15, wherein the disparity motion is of 4-pel accuracy.

28. The apparatus of claim 15, embodied at least partially as at least one integrated circuit.

29. An apparatus, comprising:
means for encoding a first sequence of input pictures and a second sequence of input pictures into a bitstream, wherein a first input picture of the first sequence of input pictures may or may not be intended for output, and wherein a second input picture of the second sequence of input pictures is intended for output;
means for including a disparity signal indication indicative of a disparity motion;
means for using a motion derivation method to derive at least one motion vector from the first input picture according to the disparity motion; and
means for using the at least one derived motion vector in encoding the second input picture.

30. The apparatus of claim 29, where the disparity motion is of 8-pel accuracy.

31. A method, comprising:
encoding a first sequence of input pictures and a second sequence of input pictures into a bitstream;
signalling in a slice header of the first sequence of input pictures whether motion is generated by derivation from pictures in the second sequence.

32. A computer readable memory medium storing computer program instructions configured to perform the processes of claim 31.

33. An apparatus, comprising:
a processor; and
a memory unit communicatively connected to the processor and including:
computer code configured to encode a first sequence of input pictures and a second sequence of input pictures into a bitstream; and
computer code configured to signal in a slice header of the first sequence of input pictures whether motion is generated by derivation from pictures in the second sequence.

34. The apparatus of claim 33, embodied at least partially as at least one integrated circuit.

35. An apparatus, comprising:
means for encoding a first sequence of input pictures and a second sequence of input pictures into a bitstream; and
means for signalling in a slice header of the first sequence of input pictures whether motion is generated by derivation from pictures in the second sequence.

36. The apparatus of claim 35, embodied at least partially as at least one integrated circuit.

37. A method, comprising:
encoding a first sequence of input pictures and a second sequence of input pictures into a bitstream; and
signalling in a network abstraction layer unit header whether a picture of the second sequence of input pictures is used by at least one picture in the first sequence of input pictures for motion skip.

38. A computer readable memory medium storing computer program instructions configured to perform the processes of claim 37.

39. An apparatus, comprising:
a processor; and
a memory unit communicatively connected to the processor and including:
computer code configured to encode a first sequence of input pictures and a second sequence of input pictures into a bitstream; and
computer code configured to signal in a network abstraction layer unit header whether a picture of the second sequence of input pictures is used by at least one picture in the first sequence of input pictures for motion skip.

40. The apparatus of claim 39, embodied at least partially as at least one integrated circuit.

41. An apparatus, comprising:
means for encoding a first sequence of input pictures and a second sequence of input pictures into a bitstream; and
means for signalling in a network abstraction layer unit header whether a picture of the second sequence of input pictures is used by at least one picture in the first sequence of input pictures for motion skip.

42. The apparatus of claim 41, embodied at least partially as at least one integrated circuit.

43. A method, comprising:
receiving a first sequence of input pictures and a second sequence of input pictures from a bitstream;
receiving a signal in a network abstraction layer unit header, the signal indicating whether a picture of the second sequence of input pictures is used by at least one picture in the first sequence of input pictures for motion skip; and
if the signal indicates that a picture of the second sequence of input pictures is used by at least one picture in the first sequence of input pictures for motion skip, using the picture in the second sequence of input pictures for motion skip when decoding the at least one picture in the first sequence of input pictures.

44. A computer readable memory medium storing computer program instructions configured to perform the processes of claim 43.

45. An apparatus, comprising:
a processor; and
a memory unit communicatively connected to the processor and including:
computer code configured to process a received first sequence of input pictures and a second sequence of input pictures from a bitstream;
computer code configured to process a received signal in a network abstraction layer unit header, the signal indicating whether a picture of the second sequence of input pictures is used by at least one picture in the first sequence of input pictures for motion skip; and
computer code configured to, if the signal indicates that a picture of the second sequence of input pictures is used by at least one picture in the first sequence of input pictures for motion skip, use the picture in the second sequence of input pictures for motion skip when decoding the at least one picture in the first sequence of input pictures.

46. The apparatus of claim 45, embodied at least partially as at least one integrated circuit.

47. An apparatus, comprising:
means for receiving a first sequence of input pictures and a second sequence of input pictures from a bitstream;
means for receiving a signal in a network abstraction layer unit header, the signal indicating whether a picture of the second sequence of input pictures is used by at least one picture in the first sequence of input pictures for motion skip; and
means for, if the signal indicates that a picture of the second sequence of input pictures is used by at least one picture in the first sequence of input pictures for motion skip, using the picture in the second sequence of input pictures for motion skip when decoding the at least one picture in the first sequence of input pictures.

48. The apparatus of claim 47, embodied at least partially as at least one integrated circuit.

49. A method, comprising:
receiving a first sequence of input pictures and a second sequence of input pictures, a slice header of the first sequence of input pictures including a signal regarding whether motion is generated by derivation from pictures in the second sequence; and
if the signal in the slice header of the first sequence of input pictures indicates that motion is generated by derivation from pictures in the second sequence, using motion derived from the pictures in the second sequence to decode at least one of the first sequence of input pictures.

50. A computer readable memory medium storing computer program instructions configured to perform the processes of claim 49.

51. An apparatus, comprising:
a processor; and
a memory unit communicatively connected to the processor and including:
computer code configured to process a received first sequence of input pictures and a second sequence of input pictures, a slice header of the first sequence of input pictures including a signal regarding whether motion is generated by derivation from pictures in the second sequence; and
computer code configured to, if the signal in the slice header of the first sequence of input pictures indicates that motion is generated by derivation from pictures in the second sequence, use motion derived from the pictures in the second sequence to decode at least one of the first sequence of input pictures.

52. The apparatus of claim 51, embodied at least partially as at least one integrated circuit.

53. An apparatus comprising:
means for receiving a first sequence of input pictures and a second sequence of input pictures, a slice header of the first sequence of input pictures including a signal regarding whether motion is generated by derivation from pictures in the second sequence; and
means for, if the signal in the slice header of the first sequence of input pictures indicates that motion is generated by derivation from pictures in the second sequence, using motion derived from the pictures in the second sequence to decode at least one of the first sequence of input pictures.

54. The apparatus of claim 53, embodied at least partially as at least one integrated circuit.

55. A method, comprising:
encoding a first sequence of input pictures and a second sequence of input pictures into a bitstream, where a first input picture of the first sequence of input pictures may or may not be intended for output, and where a second input picture of the second sequence of input pictures is intended for output;
including a disparity signal indication indicative of a macroblock disparity motion;
using a motion derivation method to derive at least one motion vector from the first input picture according to the disparity motion; and
using the at least one derived motion vector for motion compensation.

56. The method of claim 55, further comprising including at least one indication in the bitstream, the at least one indication being indicative of at least one of whether a picture is used in the deriving of the at least one motion vector, whether a view uses any other view for inter-view sample prediction, and whether single-loop decoding is supported for a view.

57. A computer readable memory medium storing computer program instructions configured to perform the processes of claim 55.

58. A computer-readable memory medium that stores computer program instructions, the execution of which result in operations that comprise:
encoding a first sequence of input pictures and a second sequence of input pictures into a bitstream, where a first input picture of the first sequence of input pictures may or may not be intended for output, and where a second input picture of the second sequence of input pictures is intended for output;
including a disparity signal indication indicative of a macroblock disparity motion; and
using a motion derivation method to derive at least one motion vector from the first input picture according to the disparity motion, the at least one derived motion vector being used for motion compensation.

59. The computer-readable memory medium of claim 58, where at least one indication is included in the bitstream, the at least one indication being indicative of at least one of whether a picture is used in the deriving of the at least one motion vector, whether a view uses any other view for inter-view sample prediction, and whether single-loop decoding is supported for a view.

60. An apparatus, comprising:
means for encoding a first sequence of input pictures and a second sequence of input pictures into a bitstream, where a first input picture of the first sequence of input pictures may or may not be intended for output, and where a second input picture of the second sequence of input pictures is intended for output;
means for including a disparity signal indication indicative of a macroblock disparity motion;
means for using a motion derivation method to derive at least one motion vector from the first input picture according to the disparity motion, the at least one derived motion vector being used for motion compensation; and
means for including at least one further indication in the bitstream, the at least one further indication being indicative of at least one of whether a picture is used in the deriving of the at least one motion vector, whether a view uses any other view for inter-view sample prediction, and whether single-loop decoding is supported for a view.

61. The apparatus of claim 60, embodied at least partially as at least one integrated circuit.
